(19) United States
(12) Patent Application Publication
(10) Pub. No.: US 2010/0233548 A1
(43) Pub. Date: Sep. 16, 2010

(54) SOLID-STATE BATTERY AND METHOD FOR MANUFACTURING OF SUCH A SOLID-STATE BATTERY

(75) Inventors: Remco Henricus Wilhelmus Pijnenburg, Hoogeloon (NL); Petrus Henricus Laurentius Notten, Eindhoven (NL); Rogier Adrianus Henrica Niessen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/671,928

(22) PCT Filed: Jun. 5, 2008
(86) PCT No.: PCT/IB08/52217

§ 371 Date: Feb. 3, 2010

(30) Foreign Application Priority Data
Jun. 7, 2007 (EP) 07109773.7

(51) Int. Cl. H01M 10/36; H01M 10/04; H01M 4/02

(52) U.S. Cl. 429/322; 29/623.5; 429/246

(57) ABSTRACT

Batteries based on solid-state electrolytes are known in the art. These (planar) energy sources, or solid-state batteries, efficiently convert chemical energy into electrical energy and can be used as the power sources for portable electronics. The invention relates to a method for manufacturing of a solid-state battery in which the pinholes in a solid electrolyte are at least partially filled by the deposition of an electrically insulating layers. The invention also relates to a battery obtained by performing such a method. The invention further relates to an electronic device provided with such a battery.

### FIELD OF THE INVENTION

The invention relates to a method for manufacturing of a solid-state battery. The invention also relates to a battery obtained by performing such a method. The invention further relates to an electronic device provided with such a battery.

### BACKGROUND OF THE INVENTION

Batteries based on solid-state electrolytes are known in the art. These (planar) energy sources, or ‘solid-state batteries’, efficiently convert chemical energy into electrical energy and can be used as the power sources for portable electronics. At small scale such batteries can be used to supply electrical energy to e.g. microelectronic modules, more particular to integrated circuits (IC's). An example hereof is disclosed in the international patent application WO2005/027245, where a solid-state thin-film battery, in particular a lithium ion battery, comprises a structured silicon substrate onto which a stack of a silicon anode, a solid-state electrolyte, and a cathode are deposited successively. An example of a suitable solid-state electrolyte is LiPON (Lithium Phosphorus Oxynitride). Nowadays, LiPON is one of the most promising and most used electrolytes for all-solid-state lithium ion batteries. This material is a good insulator for electrons (σₑₗ=10⁻¹⁴ S/cm at 25° C.), and (compared with other solid-state electrolytes) a relative good conductor for lithium ions (σᵢₒₙ=2.10⁻⁶ S/cm at 25° C.). Moreover, UPON is electrochemically stable. However, the lithium ion conductivity of most liquid electrolytes is about two orders of magnitude higher than that of UPON. Nevertheless, the performance of solid-state electrolytes can still approach (or maybe even exceed) the performance of liquid electrolytes, because solid-state electrolytes can be made very thin, and the resistance of the solid-state electrolyte will decrease when the electrolyte thickness decreases. For this reason, it is important to manufacture the solid-state electrolyte as thin as possible, as long as the breakdown field over the electrolyte is not exceeded. It has been found, however, that it is very difficult to deposit pinhole-free UPON layers with a thickness below 1 micron, wherein it is noted that already a single pinhole in the solid-state electrolyte can result in shorted electrodes, and hence in a shorted battery. Hence, to prevent formation of pinholes in the electrolytic layer, and hence to prevent a shorted battery, existing all-solid-state batteries commonly have an electrolytic layer with a safe thickness of about 3 micron or thicker.

It is an object to provide an improved method for manufacturing of an all-solid-state battery comprising a relatively thin electrolytic layer.

### SUMMARY OF THE INVENTION

This object can be achieved by providing a method according to the preamble, comprising the steps of: A) depositing a first electrode onto a substrate, B) depositing a solid-state electrolytic layer onto said first electrode, and C) depositing a second electrode onto said solid-state electrolyte, wherein the method further comprises step D) comprising depositing a electrical insulating layer onto the electrolytic layer to at least partially fill up pinholes eventually formed in the electrolytic layer, wherein step D) is carried out prior to step C). By depositing an electrical insulating layer onto the electrolytic layer, pinholes eventually formed in the electrolytic layer can be filled up at least partially, and eventually completely, by the electrical insulating material to secure complete physical and electrical separation of the first electrode and the second electrode. By means of this method according to the invention still a relatively thin solid-state electrolytic layer can be applied which will decrease the resistance of the electrolyte and hence of the battery as such to be obtained, which will be in favour of the performance of the battery. The electrical insulating layer may still be present during deposition of the second electrode according to step C). However, in this latter case it is preferably to apply an electrical insulating material which is conductive for active species contained by the battery to secure proper battery operation. Thus, in this case the electrical insulating material is preferably also an electrolytic material (ionically conducting material). Deposition of the electrical insulating layer (and preferably also the other layers) is preferably realised by means of one of the following techniques: chemical vapour deposition (CVD), physical vapour deposition (PVD), atomic layer deposition (ALD), or sol-gel (impregnation) techniques. The layer thickness of said electrical insulating, electrolytic layer is preferably kept to a minimum to minimise the resistance of the assembly (laminate) of electrolytes which will be in favour of the battery performance. In an alternative preferred embodiment, the method further comprises step E) comprising reducing the layer thickness of the electrical insulating layer deposited during step D) to allow subsequent deposition of the second electrode, preferably directly, onto the electrolytic layer according to step C). In this manner, the effective thickness of the electrolytic layer can be kept to a minimum, while pinholes eventually formed within the electrolytic layer are filled up by the electrical insulating material, as a result of which the battery performance can be optimised in a relatively effective and efficient manner. In a′ preferred embodiment of the method according to the invention the thickness of the electrical insulating layer is reduced by etching back the electrical insulating layer. In general, etching techniques, such as dry etching and wet etching, are known to pattern layers, wherein the etching techniques are commonly combined with conventional photolithographic masking. In an alternative embodiment, the electrical insulating material is removed position-selectively by polishing techniques, in particular chemical-mechanical polishing (“CMP”) techniques, wherein a moving pad is biased against the electrical insulating material surface to be polished, with the interposition of a slurry containing finely-dimensioned abrasive particles (and other ingredients) therebetween. As a result of the CMP processing, the excess of the electrical insulating material is removed position-selectively, wherein preferably merely electrical insulating material will remain in one or multiple pinholes initially formed in the electrolytic layer.

The layer thickness of the solid-state electrolytic layer is preferably less than 500 nm, preferably 100 nm, more preferably less than 60 nm, and most preferably substantially 50 nm. In this manner a relatively thin electrolytic layer is applied, leading—compared to known (relatively thick) electrolytic layers—to a considerable decrease of the impedance of the electrolytic layer, resulting in a considerably improved battery performance.

The solid-state electrolyte and/or the electrical insulating material is preferably made of at least one material selected from the group consisting of: Li₅La₃Ta₂O₁₂ (Garnet-type class), LiPON, LiNbO₃, LiTaO₃, Li₉SiAlO₈, and Li_{0.5}La_{0.5}TiO₃ (Perovskite-type). Other solid-state electrolyte materials which may be applied smartly are lithium orthotungstate (Li₂WO₄), Lithium Germanium Oxynitride (LiGeON), Li₁₄ZnGe₄O₁₆ (lisicon), Li₃N, beta-aluminas, or Li_{1.3}Ti_{1.7}Al_{0.3}(PO₄)₃ (nasicon-type). A proton conducting electrolyte may for example be formed by TiO(OH), or ZrO₂Hₓ. In an alternative preferred embodiment the electrical insulating material is made of a polymer or an oxide, such as SiO₂, HfO₂, Ta₂O₅, BaₓSr_{y}TiO₃, PbₓLa_{y}Zr_{z}TiO₃ (PLZT), SiNₓ, and ZnO. It will be clear that also other materials may be employed to act as insulating filling material for filling eventual pinholes.

The first electrode commonly comprises a cathode, and the second electrode commonly comprises an anode (or vice versa). In a preferred embodiment the cathode is made of at least one material selected from the group consisting of: LiCoO₂, LiMn₂O₄, LiFePO₄, V₂O₅, MoO₃, WO₃, and LiNiO₂. It has been found that at least these materials are highly suitable to be applied in lithium ion energy sources. Examples of a cathode in case of a proton based energy source are Ni(OH)₂ and NiM(OH)₂, wherein M is formed by one or more elements selected from the group of e.g. Cd, Co, or Bi. It may be clear that also other cathode materials may be used in the battery obtained by the method according to the invention. The anode is preferably made of at least one material selected from the group consisting of: Li metal, Si-based alloys, Sn-based alloys, Al, Si, SnOₓ, Li₄Ti₅O₁₂, SiOₓ, LiSiON, LiSnON, and LiSiSnON, in particular LiₓSiSn_{0.87}O_{1.20}N_{1.72}.

Preferably, at least one electrode of the energy source according to the invention is adapted for storage of active species of at least one of following elements: hydrogen (H), lithium (Li), beryllium (Be), magnesium (Mg), aluminum (Al), copper (Cu), silver (Ag), sodium (Na) and potassium (K), or any other suitable element which is assigned to group 1 or group 2 of the periodic table. So, the battery obtained by the method according to the invention may be based on various intercalation mechanisms and is therefore suitable to form different kinds of (reserve-type) battery cells, e.g. Li-ion battery cells, NiMH battery cells, et cetera. In a preferred embodiment at least one electrode, more particularly the battery anode, comprises at least one of the following materials: C, Sn, Ge, Pb, Zn, Bi, Sb, Li, and, preferably doped, Si. A combination of these materials may also be used to form the electrode(s). Preferably, n-type or p-type doped Si is used as electrode, or a doped Si-related compound, like SiGe or SiGeC. Also other suitable materials may be applied as anode, preferably any other suitable element which is assigned to one of groups 12-16 of the periodic table, provided that the material of the battery electrode is adapted for intercalation and storing of the abovementioned reactive species. The aforementioned materials are in particularly suitable to be applied in lithium ion based battery cells. In case a hydrogen based battery cell is applied, the anode preferably comprises a hydride forming material, such as AB₅-type materials, in particular LaNi₅, and such as magnesium-based alloys, in particular MgₓTi₁₋ₓ.

The method preferably further comprises step F) and step G), step F) comprising depositing a first current collector onto the substrate prior to the deposition of the first electrode according to step A), and step G) comprising depositing a second current collector onto the second electrode after the deposition said second electrode according to step C). By means of the current collectors the battery can easily be connected to an electronic device. Preferably, the current collectors are made of at least one of the following materials: Al, Ni, Pt, Au, Ag, Cu, Ta, Ti, TaN, and TN. Other kinds of current collectors, such as, preferably doped, semiconductor materials such as e.g. Si, GaAs, InP may also be applied.

In a preferred embodiment, the method further comprises step H) comprising depositing an electron-conductive barrier layer onto the substrate prior to the deposition of the first electrode according to step A), said barrier layer being adapted to at least substantially preclude diffusion of active species contained by the first electrode into said substrate. In this manner the substrate and the electrochemical cell will be separated chemically, as a result of which the performance of the electrochemical cell can be maintained relatively long-lastingly. In case a lithium ion based cell is applied, the barrier layer is preferably made of at least one of the following materials: Ta, TaN, Ti, and TiN. It may be clear that also other suitable materials may be used to act as barrier layer. Preferably, step F) and step H) are integrated, wherein the barrier layer is preferably also employed as current collector. Commonly, it will be beneficial to position the barrier layer between the anode and the adjacent substrate.

In a preferred embodiment a substrate is applied, which is ideally suitable to be subjected to a surface treatment to pattern the substrate, which may facilitate patterning of the electrode(s). The substrate is more preferably made of at least one of the following materials: C, Si, Sn, Ti, Ge, Al, Cu, Ta, and Pb. A combination of these materials may also be used to form the substrate(s). Preferably, n-type or p-type doped Si or Ge is used as substrate, or a doped Si-related and/or Ge-related compound, like SiGe or SiGeC. Beside relatively rigid materials, also substantially flexible materials, such as e.g. foils like Kapton® foil, may be used for the manufacturing of the substrate. It may be clear that also other suitable materials may be used as a substrate material.

In a particular preferred embodiment a surface of at least one electrode facing the electrolyte is patterned at least partially. In this manner the effective contact surface area between the electrode(s) and the electrolyte is increased substantially with respect to a conventional relatively smooth contact surface of the electrode(s), resulting in a proportional increase of the rate capability of the battery obtained by the method according to the invention. Patterning the surface of one or multiple electrodes facing the electrolyte can be realised by means of various methods, among others selective wet chemical etching, physical etching (Reactive Ion Etching), mechanical imprinting, and chemical mechanical polishing (CMP). The pattern of the electrode(s), increasing the contact surface area between the electrode(s) and the electrolyte, can be shaped in various ways. Preferably, the patterned surface of at least one electrode is provided with multiple cavities, in particular pillars, trenches, slits, or holes, which particular cavities can be applied in a relatively accurate manner. In this manner the increased performance of the battery can also be predetermined in a relatively accurate manner.

The invention also relates to a battery obtained by performing the method according to the invention, comprising a first electrode, an electrolytic layer, and a second electrode subsequently deposited onto a substrate. The electrolytic layer is provided with at least pinhole, said pinhole being at least partially filled up by an electrical insulating material electrically separating the first electrode and the second electrode to prevent short-circuiting of both electrodes. The electrolytic layer is preferably relatively thin, wherein the thickness of the electrolytic layer is less than 500 nm, preferably less than 100 nm, more preferably less than 60 nm, and particularly preferably substantially 50 nm. Other (preferred) embodiments and advantages of the battery according to the invention have been disclosed already above.

The invention further relates to an electronic device provided with at least one battery according to the invention, and at least one electronic component connected to said battery. The at least one electronic component is preferably at least partially embedded in the substrate of the battery. In this manner a System in Package (SiP) may be realized. In a SiP one or multiple electronic components and/or devices, such as integrated circuits (ICs), actuators, sensors, receivers, transmitters, et cetera, are embeddded at least partially in the substrate of the battery according to the invention. The battery according to the invention is ideally suitable to provide power to relatively small high power electronic applications, such as (bio)implantantables, hearing aids, autonomous network devices, and nerve and muscle stimulation devices, and moreover to flexible electronic devices, such as textile electronics, washable electronics, applications requiring pre-shaped batteries, e-paper and a host of portable electronic applications.

### BRIEF DESCRIPTION OF THE DRAWINGS

The invention is illustrated by way of the following non-limitative examples, wherein:

FIG. 1 shows a cross-section of a known solid-state battery comprising a relatively thin electrolytic layer, and

FIGS. 2a-2d shows the manufacturing of a battery according to the invention.

### DETAILED DESCRIPTION OF THE EMBODIMENTS

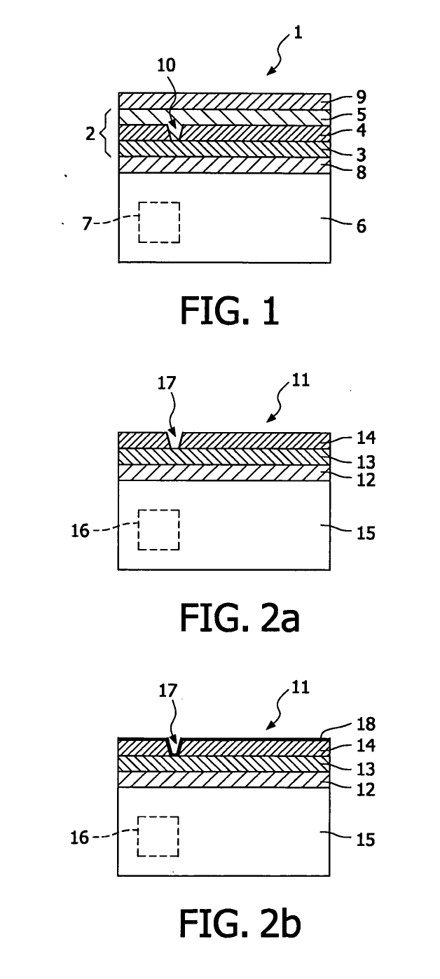

FIG. 1 shows a schematic cross section of a battery 1 known from the prior art. An example of the battery 1 shown in FIG. 1 is also disclosed in the international patent application WO2005/027245. The known battery 1 comprises a lithium ion cell stack 2 of an anode 3, a solid-state electrolyte 4, and a cathode 5, which cell stack 2 is deposited onto a substrate 6 in which one or more electronic components 7 are embedded. In this example the substrate 6 is made of intrinsic silicon, while the anode 3 is made of amorphous silicon (a-Si). The cathode 5 is made of V₂O₅, and the solid-state electrolyte 4 is made of LiPON. Between the battery stack 2 and the substrate 6 a lithium barrier layer 8 is deposited onto the substrate 6. In this example, the lithium diffusion barrier layer 8 is made of tantalum. The conductive tantalum layer 8 acts as a chemical barrier, since this layer counteracts diffusion of lithium ions (or other active species) initially contained by the stack 2 into the substrate 6. In case lithium ions would leave the stack 2 and would enter the substrate 6 the performance of the stack 2 would be affected. Moreover, this diffusion would seriously affect the electronic component(s) 7 embedded within the substrate 6. In this example, the lithium diffusion barrier layer 8 also acts as a current collector for the anode 3 in the known battery 1. The battery 1 further comprises an additional current collector 9 made of aluminum which is deposited on top of the battery stack 2, and in particularly on top of the cathode 5. Deposition of the individual layers 3, 4, 5, 8, 9 can be achieved, for example, by means of CVD, sputtering, E-beam deposition or sol-gel deposition. In this example, a relatively thin electrolytic layer 4 with a thickness of about 100 nm is deposited onto the anode 3. An advantage of applying a relatively thin electrolytic layer 4 is a relatively small resistance of this layer 4 which is in favour of the performance of the battery 1. However, a substantial risk of depositing a relatively thin electrolytic layer is the formation of pinholes 10 in the electrolytic layer 4 resulting in a short-circuiting of the anode 3 and the cathode 5. Hence, conventional thin film all-solid-state batteries are commonly equipped with thicker electrolytic layers (of about several microns) compared to the electrolytic layer 4 as shown at the expense of the battery performance in order to prevent pinhole formation in the electrolytic layer 4.

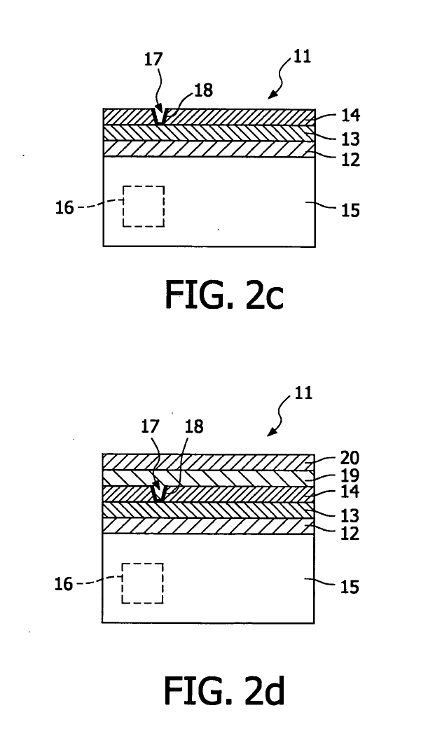

FIGS. 2a-2d shows the manufacturing of a battery 11 according to the invention. In FIG. 2a it is shown that a barrier layer 12, an anode 13, and a solid-state electrolyte 14 have been deposited subsequently onto a substrate 15 provided with one or multiple electronic components 16. As shown in this figure, the relatively thin electrolytic layer 14 of about 100 nm (in this example) is—commonly inevitably—provided with a pinhole 17 due to the confined thickness of the electrolytic layer 14. Depositing a cathode directly onto this electrolytic layer 14 would result in short-circuiting of both electrodes, and hence to battery failure. To counteract this defect in the electrolytic layer 14 an electrical insulating layer 18 is deposited directly onto the electrolytic layer 14 (see FIG. 2b). As shown in FIG. 2b the electrical insulating layer 18 (dielectric layer) is also deposited into the pinhole 17 thereby shielding the (still uncovered part of the) anode 13. The thickness of the insulating layer 18 is about 50 nm in this example. The excess of insulating material 18 is removed by means of conventional etching and/or polishing techniques (see FIG. 2c). Merely the pinhole 17 will still be provided with insulating material 18 after etching or polishing. Although it is shown that the pinhole 17 is partially filled up by the insulating material 18, it may be clear that it is also conceivable that the pinhole 17 can completely be filled up by the insulating material 18. After this processing step a cathode 19 and a current collector 20 are deposited subsequently (see FIG. 2d). The relatively thin electrolytic layer 14 will have a relatively small resistance which will be in favour of the performance of the battery 1 according to the invention. Thus by performing the method according to the invention a relatively thin, high performance battery 11 can be manufactured in a relatively simple and efficient manner.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Method for manufacturing of a solid-state battery, comprising the steps of:
A) depositing a first electrode onto a substrate,
B) depositing a solid-state electrolytic layer onto said first electrode, and
C) depositing a second electrode onto said solid-state electrolytic layer,
wherein the method further comprises step D) comprising depositing a electrical insulating layer onto the electrolytic layer to at least partially fill up pinholes eventually formed in the electrolytic layer, wherein step D) is carried out prior to step C).

2. Method according to claim 1, characterized in that the electrical insulating layer is made of an electrolytic material.

3. Method according to claim 1, characterized in that the method further comprises step E) comprising reducing the layer thickness of the electrical insulating layer deposited during step D) to allow subsequent deposition of the second electrode onto the electrolytic layer according to step C).

4. Method according to claim 3, characterized in that during step E) the thickness of the electrical insulating layer is reduced by etching back the electrical insulating layer.

5. Method according to claim 3, characterized in that during step E) the thickness of the electrical insulating layer is reduced by polishing the electrical insulating layer.

6. Method according to claim 1, characterized in that the layer thickness of the solid-state electrolytic layer deposited during step B) is less than 500 nm, preferably 100 nm, more preferably less than 60 nm, and particularly preferably substantially 50 nm.

7. Method according to claim 1, characterized in that the first electrode is formed by an anode and that the second electrode is formed by a cathode.

8. Method according to claim 1, characterized in that the method further comprises step F) and step G), step F) comprising depositing a first current collector onto the substrate prior to the deposition of the first electrode according to step A), and step G) comprising depositing a second current collector onto the second electrode after the deposition said second electrode according to step C).

9. Method according to claim 1, characterized in that the method further comprises step H) comprising depositing an electron-conductive barrier layer onto the substrate prior to the deposition of the first electrode according to step A), said barrier layer being adapted to at least substantially preclude diffusion of active species contained by the first electrode into said substrate.

10. Method according to claim 1, characterized in that at least one layer of the battery is deposited by means of one of the following techniques: chemical vapour deposition (CVD), physical vapour deposition (PVD), atomic layer deposition (ALD), or sol-gel (impregnation) techniques.

11. Battery obtained by performing the method according to claim 1, comprising a first electrode, an electrolytic layer, and a second electrode subsequently deposited onto a substrate.

12. Battery according to claim 11, characterized in that the electrolytic layer is provided with at least pinhole, said pinhole being at least partially filled up by an electrical insulating material electrically separating the first electrode and the second electrode.

13. Battery according to claim 11, characterized in that the thickness of the electrolytic layer is less than 500 nm, preferably 100 nm, more preferably less than 60 nm, and particularly preferably substantially 50 nm.

14. Battery according to claim 11, characterized in that the solid-state electrolyte and/or the electrical insulating material is made of at least one material selected from the group consisting of: Li5La3Ta2O12, LiPON, LiNbO3, Li3N, beta-aluminas, Li1.3Ti1.7Al0.3(PO4)3, LiTaO3, LiGeON, Li2WO4, Li14ZnGe4O16 Li9SiAlO8, Li0.5La0.5TiO3, TiO(OH), and ZrO2Hx.

15. Battery according to claim 11, characterized in that the electrical insulating material is made of a polymer and/or an oxide, preferably SiO2, HfO2, Ta2O5, BaxSryTiO3, PbxLayZrzTiO3 (PLZT), SiNx, and ZnO.

16. Battery according to claim 11, characterized in that at least one of the first electrode and the second electrode is adapted for storage of ions of at least one of following elements: H, Li, Be, Mg, Cu, Ag, Al, Na and K.

17. Battery according to claim 11, characterized in that at least one of the first electrode and the second electrode is made of at least one of the following materials: C, Sn, Ge, Pb, Zn, Bi, Sb, and, preferably doped, Si.

18. Battery according to claim 17, characterized in that the substrate comprises Si.

19. Electronic device provided with at least one battery according to claim 11.

20. Electronic device according to claim 19, characterized in that the at least one electronic component, in particular an integrated circuit (IC), is at least partially embedded in the substrate of the battery.

21. Electronic device according to claim 19, characterized in that the electronic device and the battery form a System in Package (SiP).
